(19) United States
(12) Patent Application Publication
(10) Pub. No.: US 2014/0048060 A1
(43) Pub. Date: Feb. 20, 2014

(54) Method of dissolving natural polymers

(71) Applicant: Jaakko Hiltunen, Espoo (FI)

(72) Inventor: Jaakko Hiltunen, Espoo (FI)

(73) Assignee: TEKNOLOGIAN TUTKIMUSKESKUS VTT, VTT (FI)

(21) Appl. No.: 14/009,797

(22) PCT Filed: Apr. 13, 2012
(86) PCT No.: PCT/FI12/50369

§ 371 Date: Nov. 6, 2013

(30) Foreign Application Priority Data
Apr. 13, 2011 (FI) 20115352

(51) Int. Cl. C08B 37/00

(52) U.S. Cl. CPC C08B 37/00
USPC 127/33; 127/36; 127/34

(57) ABSTRACT

A solution of a polysaccharide material, a method of producing such solutions and uses thereof. The solution is formed by the polysaccharide in a solvent which comprises an efficient amount of an active compound selected from the group of diketo compounds, such as glyoxylic acid and salts and derivatives thereof, capable of reacting with the polysaccharide. The solution thus produced can be used as a viscous dope, and for the production of fibers, films and surface coatings and for gluing.

### BACKGROUND OF THE INVENTION

1. Field of the Invention

The present invention relates to dissolution of natural polymers such as cellulose, hemicellulose and lignin as well as wood and various annual and perennial plants and parts thereof. In particular the present invention concerns solutions and homogeneous dispersions of natural polymers in solvents, such as aqueous solvents, and methods of producing such solutions and dispersion, and uses thereof

2. Description of Related Art

Cellulose, hemicellulose, lignin and other polysaccharides are polymers which exhibit a very limited solubility in traditional solvents such as water, alcohols, ketones and organic acids and esters. In industry, carbon disulphide or a corresponding monohydrade of NMMO (N-methyl morpholine-n-oxide) are conventionally used in the production of regenerated cellulose pulp, but both of these are problematic either because of toxicity or lack of stability but also price-wise. Further, an increasing number of ionic solvents have been presented in recent research literature. These special chemicals are expensive and recycling is difficult, thus further increasing the costs of the solvent system and being the source of environmental concern regarding the use of them.

It is an aim of the present invention to eliminate at least a part of the problems of the known art and to provide a novel way of dissolving, or efficiently dispersing, natural polymers.

### SUMMARY OF THE INVENTION

The present invention is based on the finding that natural polymers, such as poly-saccharides, form with certain active compounds, such as glyoxylic acid, bonds and that the derivative thus formed will be soluble in the active compound or in a solvent or a mixture thereof.

Thus, a method is provided which comprises dissolving a natural polymer, such as a polysaccharide material, in a solvent, by contacting the material in a solvent with an active compound, e.g. selected from compounds having at least two carbonyl groups and cationic compounds with an aldehyde group and a quaternary nitrogen atom, capable of reacting with the polysaccharide. Such compounds typically contain active and reactive carbonyl groups and preferably may also contain stabilizing carbonyl groups.

As a result, a solution of a polysaccharide material in a solvent is obtained. The solution can be used, for example, for the production of viscous solutions, viscous dopes, saccharide oligomers, saccharide dimers or saccharide monomers, nanofibrillar or microfibrillar materials and partly soluble glyoxylated cellulose particles, as well as for producing films, fibers and surface coatings.

More specifically, the present solutions are characterized by what is stated in the characterizing part of claim 1.

The method according to the invention is characterized by what is stated in the characterizing part of claim 19.

The uses according to the present invention are characterized by what is stated in claims 33 and 34.

Considerable advantages are obtained by the present invention. Thus, only a small amount of chemicals is needed for cellulose dissolution which means that the present process is economical. In preferred embodiments, there are no salt wastes formed. In preferred embodiments, water is the main solvent. No toxic chemicals are employed.

In a particularly preferred embodiment, glyoxalic acid is used. It is a relatively inexpensive and environmentally and toxicologically safe biochemical. It is generally highly versatile for various chemical syntheses, and is therefore produced in high market volumes.

So far glyoxalic acid has not been studied as a solvent for cellulose or other biopolymers and similar native, i.e. unmodified (underivatized) polysaccharides. JP 2007084680 and Muzzarelli, R. A. A., et al. Carbohydrate Research, 1982, Vol. 107, pp. 199-214 disclose the contacting of cellulose and chitosan, respectively, in the form of derivatives or premodified materials with glyoxalic acid mixture. However, the present novel technology provides for the dissolution of unmodified polysaccharides in compositions containing efficient amounts of an active compound bearing at least two adjacent carbonyl groups or similar compounds by producing a hemiacetal derivative of the polysaccharide compound.

In a preferred embodiment, the solution of the preceding embodiment typically comprises the reaction product of the polymer material, in particular polysaccharide material, with the glyoxylic acid or salt thereof. Thus, reaction product preferably comprises hemiacetals of the polysaccharide formed by a reaction with the glyoxylic acid or salt thereof.

Experiments carried out with glyoxalic acid shows that solutions having a concentration of 10% (by total weight) cellulose in water can be obtained by using concentrated glyoxalic acid within an hour. A 3% solution is obtained more rapidly.

The present technology provides a versatile process for various end products. To take cellulose as an example, by varying temperature, concentration of cellulose and reaction time, various products are obtained, including cross-linked cellulose, carboxylated cellulose having properties reminiscent of CMC or cellulosic fibres which are partially or totally plasticized. Stable acetalized products can be prepared in the same process as used for dissolving and precipitating cellulose, by increasing reaction temperature.

The present invention can be used for dissolving various natural polymers, not only cellulose, but also hemicellulose, lignin, wood and other plant species.

The present invention can also be used for biomass hydrolysis: Glyoxylic acid is capable of dissolving wood. Extensive hydrolysis of polysaccharides takes place at increased temperatures, in particular if T>100° C., typically up to a maximum of 350° C., in particular max. 280° C. It has also been found that microbes tolerate glyoxylic acid much better than they tolerate mineral acids, which allows for the use of glyoxlic acid treated solutions and product for production of various biochemicals.

Next the invention will be examined in more closely using a detailed description and with reference to a number of working examples.

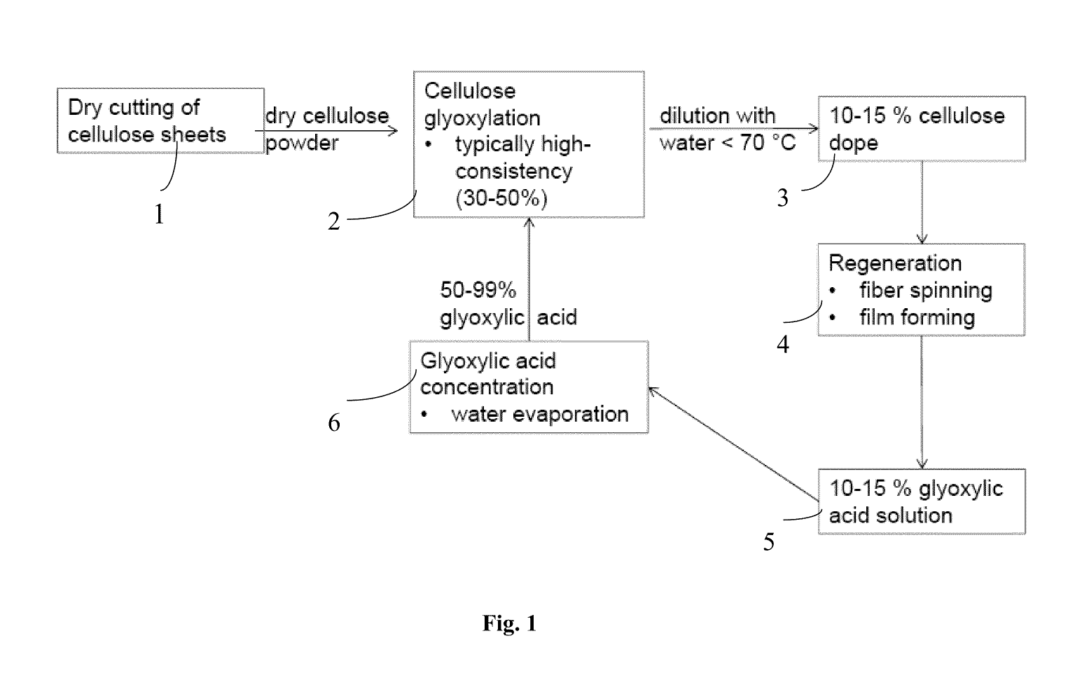

FIG. 1 shows in a schematic form the flow sheet of a process for producing fibres and films;

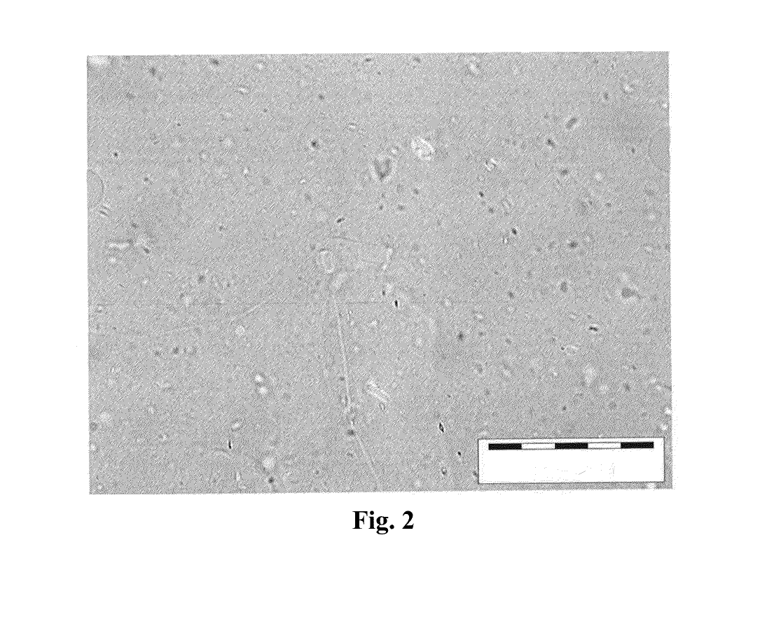

FIG. 2 shows an SEM image of a sample of 10% cellulosic solution in glyoxylic acid;

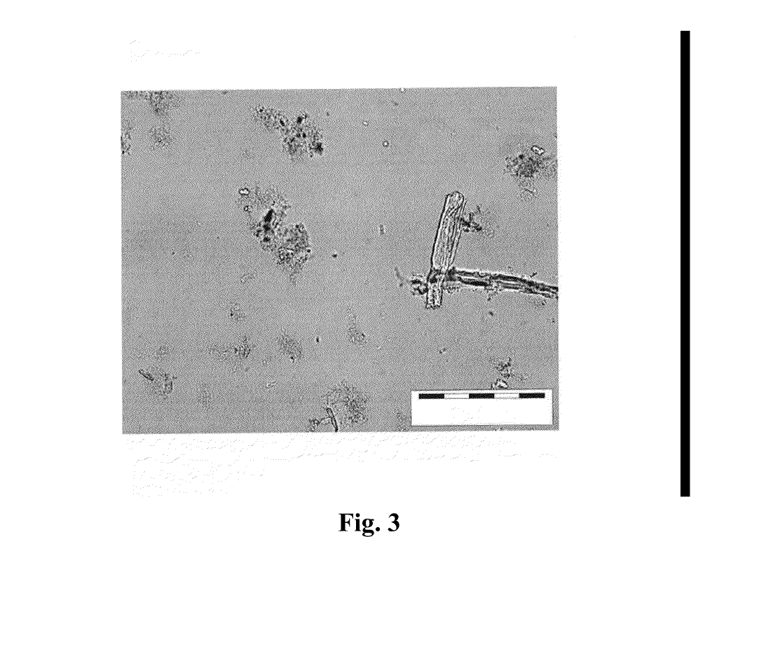

FIG. 3 shows an SEM image of a sample of high consistency (30% cellulose in glyoxylic acid) indicating the forming of intermolecular bridges between the cellulose chains; the product was strongly swelling in water but not soluble, reaction temperature 100 deg C., 1 h;

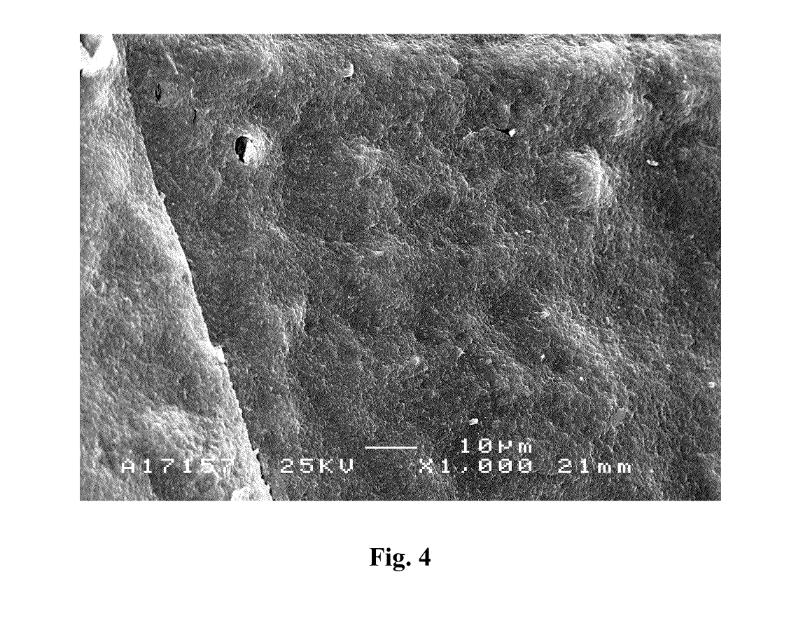

FIG. 4 shows an SEM image of the precipitated sample of Example 1; the image indicates that there is no fibrillar material present;

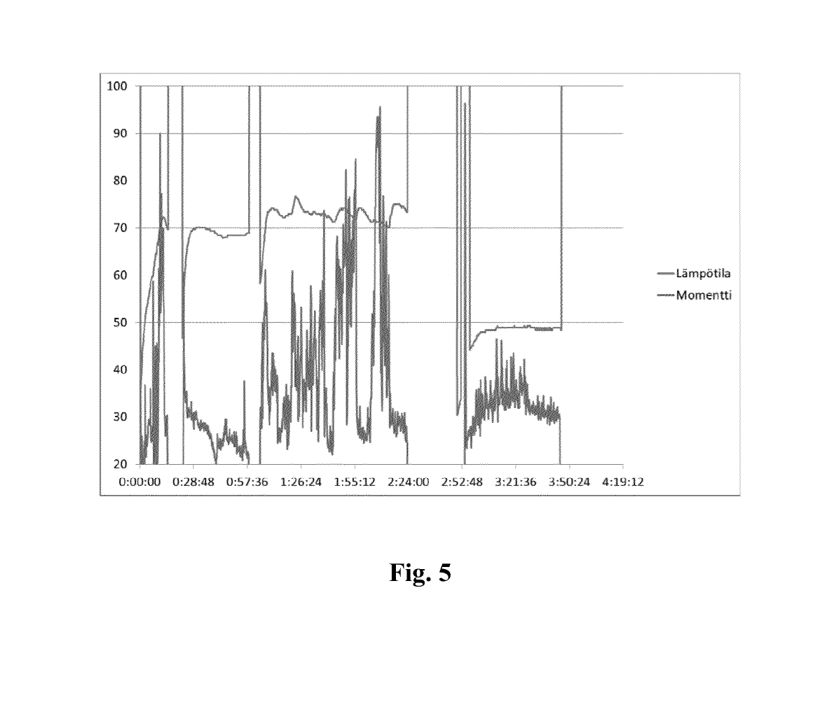

FIG. 5 shows the viscosity of a sample precipitated by boiling;

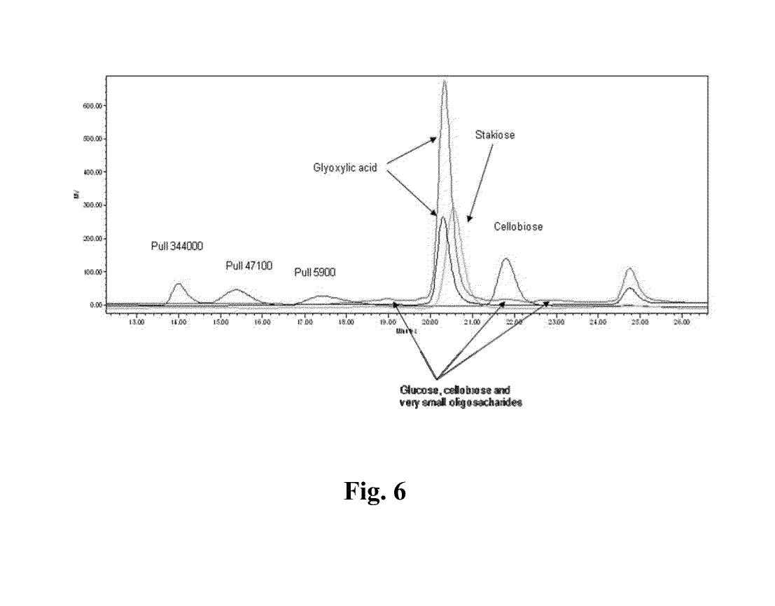

FIG. 6 shows a GPC diagramme for a sample of dissolved cellulose;

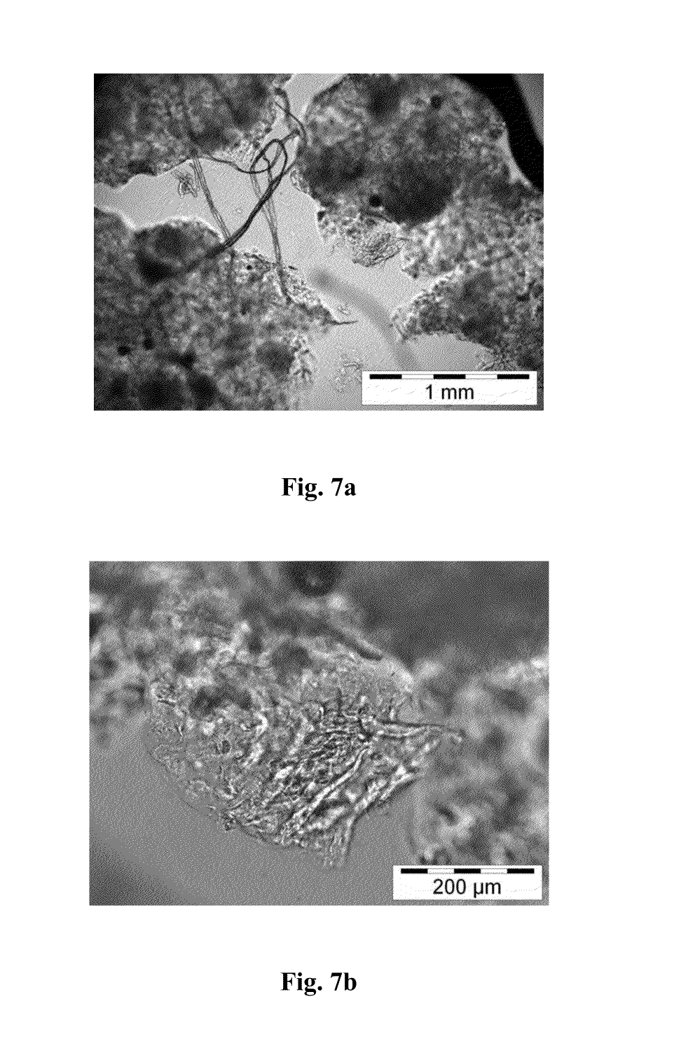

FIGS. 7a and 7b show two SEM images of two samples obtained in Example 7.

As discussed above, the present invention provides in a first embodiment a solution of a natural polymer in a solvent. The natural polymer is preferably, at least partially, comprised of a polysaccharide or a polymer derived thereof. Typically, the polysaccharide has free hydroxy groups.

The solvent or solvent phase of the solution is preferably composed of a liquid which contains a active compound which together form a solvent system capable of dissolving the natural polymer. The concentration of the active compound is sufficient for dissolving in toto, or at least partially, the polymer to form a solution of the polymer in the solvent. Preferably, the liquid phase is clear.

Although the provision of a clear solution is preferred, the present technology also allows for the production of dispersion. Thus, in another embodiment, dispersions comprising a non-settling colloidal polymer in a liquid phase are provided.

For the purpose of such embodiments, the dispersion is provided in the form of colloid mixtures, which designate heterogeneous mixtures where small particles of one substance are distributed evenly throughout another substance. The particles of a colloid mixture have typically one characteristic dimension, which is between about 1 and 1500 nm, preferably in the range of 1 nm to 1000 nm.

The dispersion according to the above embodiment is considered to be non-settling if, upon standing at room temperature for at least 24 hours, less than 10 wt-% of the total amount of solids of the dispersion is precipitated or settled out.

The dispersions may be derived from e.g wood and may therefore contain wood-derived components which are not as such soluble in the solvent mixture. Such components are exemplified by lignin and degradation products of lignin, as well as partly soluble glyoxylated cellulose particles.

According to a further embodiment of the present technology, the natural polymer is dissolved in a solvent which comprises an efficient amount of an organic compound which is capable of reacting with the polysaccharide.

In particular, the active compound or “organic compound” referred to above is selected from the group of compounds bearing at least two adjacent carbonyl groups. Other suitable compounds are cationic compounds having an aldehyde group and a quaternary nitrogen atom.

In one embodiment, the active compounds are selected from diketo compounds such as oxocarboxylic acids, for example glyoxylic acid, and derivatives and salts and mixtures thereof.

Other compounds of interest are alloxan monohydrate, 4-formyl-1-methylpyridinium benzenesulfonate and other anions, mesoxalic acid, mesoxalate, betaine aldehyde and methylglyoxal.

In one or more of the above listed compounds there are active and reactive carbonyl groups. Further the compounds contain or may contain stabilizing carbonyl groups.

The preferred compounds exhibit a capability of solubilizing the polymer and of stabilizing the complexes formed.

In particular, the active compounds containing carbonyl groups (C═O) reacts with the hydroxyl groups of the polysaccharide to form a hemiacetal derivative of the polysaccharide. The hemiacetal derivative is soluble in a solvent, e.g. in an excess of the active compound. The hemiacetal bond is reversible and it is hydrolysed in water. This allows for regeneration of the polysaccharide to produce, for example, fibres or films or coatings, as will be discussed below.

In one embodiment, the hemiacetal derivative is dissolved in water or another polar solvent or in an aqueous solvent, e.g. an aqueous polar solvent, to a low consistency of the polysaccharide (about 0.1 to 10% by weight of the total composition). Then hemiacetal cleavage is achieved by heating the solution to a temperature up to the boiling point of the solvent, in the case of water to about 50 to 120° C., depending on pressure. Hemiacetal cleavage will lead to polysaccharide regeneration by heating.

The hemiacetal bonds of the hemiacetal derivative can also be converted to acetal bonds by elimination of water. This can take place at higher temperatures. As a result, in the case of cellulose, carboxysilated cellulose which is reminiscent of CMC (carboxymethyl cellulose).

In the present technology, the solvent is preferably a polar solvent, such as water.

Non-aqueous solvents, for example non-aqueous protic or aprotic solvents, preferably a non-nucleophilic solvents, can also be employed.

In a preferred embodiment, wherein the solvent is water, and a diketo compound is employed as an active compound, water is bound to the diketo compound.

Solvent mixtures can also be employed.

In an embodiment, any free solvent in the mixture formed by the polymer and bound solvent is formed by a non-aqueous solvent. Such a non-aquoeus solvent can be a non-nucleophilic solvent.

In a further embodiment, the natural polymer is a polymer obtained from an organic material, for example a vegetable material, such as annual or perennial plants, or from algae or animal materials.

In a preferred embodiment, the natural polymer is a polysaccharide material which comprises or consists of or consists essentially of a polysaccharide selected from the group of cellulose, hemicelluloses, lignocellulosic materials, starch and chitosan and mixtures thereof.

In another embodiment, the natural polymer is a polysaccharide material which is formed by a matrix, for example a fibrous or particulate matrix, comprising a polysaccharide polymer selected from cellulose, hemicelluloses, lignocellulosic materials, starch and chitosan and mixtures thereof.

The present technology provides for solutions prepared from isolated polymers and polymers present in a matrix material, e.g. a fibrous or particulate matrix.

In one embodiment the solution comprises 1 to 50%, preferably 5 to 40%, by mass of the natural polymer, e.g. of the polysaccharide or polysaccharide material, and 50 to 99%, preferably 60 to 95%, by mass of the liquid phase, in particular solvent, preferably aqueous solvent or solvent phase.

The polysaccharide subjected to the present treatment is unmodified, i.e. it is typically unsoluble in water, in particular in water at ambient temperatures (5 to 30° C.) or at moderately increased temperatures (up to about 80° C.). Thus, the terms “polysaccharide” and “polysaccharide material” are used in the present application to designate native or underivatized polysaccharides and polysaccharide polymers as well as materials containing such polysaccharides and polysaccharide polymers. The polysaccharides and polysaccharide materials are typically not subjected to any chemical pretreatment, e.g. any treatment that would modify its properties of solubility, before the present treatment.

As stated above, the polymer of the polysaccharide material preferably exhibits free hydroxy groups and is capable of forming a hemiacetal with the active compound.

In a preferred embodiment, the present method comprises the step of dissolving a polysaccharide material in an aqueous solvent, preferably by dissolving 1 to 50 parts by weight of the polysaccharide material in 99 to 50 parts by weight of an aqueous solvent, which comprises a diketo compound.

A preferred active compound is glyoxylic acid and salts thereof.

Typically, in the case of glyoxylic acid or salts thereof, the concentration of the active compound (glyoxylic acid or salt thereof) is up to 85%, preferably up to 75%, by mass of the solvent contacted with the polysaccharide. Typically, the water content is kept at a maximum value of 30% by mass of the glyoxylic acid/liquid mixture.

After polysaccharide hemiacetalization, the viscous solution can be diluted in a solvent, typically water, to a concentration (consistency of the polysaccharide) of about 0.1 to 10% by weight. Thus, after the dilution, the solution contains generally 1 to 85%, preferably 5 to 75%, in particular 5 to 60%, by weight of the composition of the active compound.

In case of a non-aqueous solvent, for example a non-aqueous protic or aprotic solvent, preferably a non-nucleophilic solvent, is employed.

For solvent mixtures, the non-aqueous solvent can be used at a volume ratio of water to non-aqueous solvent is 10 to 90, preferably 20 to 80, in particular 30 to 70.

In any of the above embodiments, typically water is still present in the form of water bound to the active compound. At least a part of the water is present in the form of hydrated water, preferably the solution comprises 10 to 90% of free water and 90 to 10% by volume of hydrated water.

The method provided by the present technology may comprise the steps of dissolving 1 to 50 parts by weight of the polysaccharide material in an aqueous solvent comprising 1 to 40 parts, preferably 15 to 30 parts by weight of water, at least a part of the water being chemically bound to the glyoxylic acid or glyoxylate salt.

The mixture obtained from the hemiacetalization step can also be diluted for example with an aqueous alkali metal hydroxide, e.g. with NaOH or KOH, or with a quaternary nitrogenous hydroxide or alkaline potassium or magnesium salt, or with an aqueous solution of the active compound having a concentration of said compound of about 20 to 70% by weight, for example about 40 to 60% by weight of said active compound, for example glyoxylic acid, to increase solubility. In one alternative, the temperature of dilution can be 0-60° C., preferably 30-40° C.

When a derivative, in particular a salt of an oxocarboxylic acid, such as example glyoxylic acid, is used, the reaction can be carried out in a solution of the salt or in a melt formed by the salt. In the latter embodiment, the polysaccharide and the melt are mixed together, preferably under conditions of intense mixed, optionally under shear forces, and by heating the mixture to a temperature of about 40 to 120° C. A plastic mass is obtained which can be dissolved in a solution of the active compound. The examples illustrate the dissolution of the plastic mass in an aqueous solution of at least 40 to 50% by mass of glyoxylic acid or a salt thereof. The dissolution process will yield a viscous solution or dope.

An embodiment of the above alternative comprises mixing 1 to 50 parts by weight of the unmodified polysaccharide material with 99 to 40 parts by weight of a salt of the carbonyl compound in melt phase.

As already stated, the solution provided by the present technology is typically a viscous solution. The solution may exhibit a dynamic viscosity of 10 mPas to 100000 mPas, in particular 100 mPas to 75000 mPas, for example 200 to 50000 mPas.

In addition to polymers in solute phase the present solutions may also comprise oligomeric and monomeric materials. In one embodiment, saccharide oligomers, saccharide dimers, saccharide monomers or mixtures thereof, nanofibrillar or microfibrillar materials, or partly soluble glyoxylated cellulose particles or combinations and mixtures, are provided in solution.

According to a particularly preferred embodiment, cellulose is the main polymer component, in particular the main polysaccharide component. Typically at least 50% by weight of the polymer material dissolved is formed by cellulose.

The dissolution method is carried out at conditions conducive to dissolving the material in the liquid phase. The dissolution process can be continuous or discontinuous. It can be carried out in one or more phases. It is possible to carry out the whole dissolution process at constant conditions. In is also possible to carry out the process in two or more steps, whereby the conditions are different at the steps.

To avoid degradation of the active compound, the reaction can be carried out in the absence of oxygen or in an inert atmosphere or in a combination thereof.

In one preferred embodiment, a polysaccharide material is contacted with an aqueous solution, preferably containing an active compound as explained above, at a temperature of about 5 to 25° C. to form a dispersion, and increasing the temperature of the dispersion to a temperature of at least 40° C., for example at least 50° C., to dissolve the polysaccharide. Preferably, the temperature of the latter step is less than about 350° C., in particular less than about 280° C., advantageously less than about 200° C., typically less than about 80° C.

In another preferred embodiment, the mixture formed by contacting the polymer with the liquid phase is diluted with a solvent or liquid, such as water.

In an embodiment, the final water content of the solution is 15-98%.

The present solutions have a great many applications in industry. Thus, a solution as explained above or obtained according to a method as detailed above, can be used for the production of viscous solutions, viscous dopes, saccharide oligomers, saccharide dimers or saccharide monomers, nanofibrillar or microfibrillar materials and partly soluble glyoxylated cellulose particles. The viscosity of the solutions and dopes are typically in the range mentioned above.

The solution can be used for the production of fibers, for example by spinning, for the production of films, for surface coating and for gluing.

In one embodiment, the present invention provides a process shown in FIG. 1, wherein cellulose sheets are employed as a raw-material for producing a cellulose dope which can be used for production of fibers and films.

In the first stage of the method, symbolized by the first box 1, cellulose sheets are cut for example in a hammer mill or with a Wiley mill to produce cellulose powder, in particular dry cellulose powder.

In a second step 2, cellulose powder thus obtained in dissolved in a mixture of glyoxylic acid and water. The concentration of glyoxylic acid can be for example about 50 to 99%, the remainder being made up of water. Cellulose is glyoxylated (hemiacetalized) to give a mixture having high consistency.

The mixture can be worked-up with intensive mixing, for example using a compounder or extruder or similar mixer capable of providing high shear forces. The consistency of the mixture is typically about 30 to 50% by weight of the total mixture.

Step 2 can be carried out at ambient temperature and pressure. Preferably the temperature is in any case above the freezing point of water and less than about 50° C. to avoid extensive evaporation of the liquid phase.

Next, in a third step, cf. reference numeral 3, the mixture thus obtained is diluted with water at an increased temperature, typically extending to about 30 to less than 70° C. By the dilution the consistency and concentration will drop to give a cellulose solution containing about 1 to 30% by weight, in particular about 5 to 20% by weight, in particular about 5 to 15% by weight of cellulose in aqueous solution.

The cellulose dope thus obtained can be used for the production of fibers and films 4. For that purpose, water can be evaporated for example by boiling off water, or a non-solvent can be added, or a combination of evaporation of water and addition of non-solvent can be carried out. As examples of non-solvents or precipitants, lower alcohols, such methanol and ethanol can be mentioned.

After the separation of the regenerated cellulose, the solvent mixture is recovered 5 having a concentration of the glyoxylic acid at a concentration of about 1 to 30, preferably 5 to 20, in particular about 10 to 15% by weight.

The recovered mixture is then concentrated 6 by evaporation and can then be recycled for use in the second step of the process, i.e. the dissolution step 2.

### Summarizing the above Embodiments

natural, unmodified polymers can be dissolved partly or completely in aqueous glyoxylic acid and/or glyoxylate salt solutions—other diketo compounds as well as compounds having active carbonyl groups can be used as well;
in a preferred embodiment, the solution comprises a mixture 1-50% of the polymer material and 50-99% of aqueous glyoxylic acid or glyoxylate salt solutions;
in another preferred embodiment, the water content in the process during the reaction phase is 1-40%, preferably 15-30% and part of the water is chemically bounded to glyoxylic acid or glyoxylate salt (hydrated water);
after the reaction the mixture can be diluted with neutral or alkaline water to increase the solubility; the final water content in the process can be 15-98% depending on the pH and dissolution temperature;
in the reaction phase the free water (not hydrated water), can be replaced with other polar protic or aprotic solvent, preferably with non-nucleophilic solvent;
various end products can be obtained by changing process parameters (e.g time, temperature and water content); these includes viscous solutions/dopes, saccharide oligomers dimers and monomers, nanofibrillar or microfibrillar materials and partly soluble glyoxylated cellulose particles;
cellulose solutions produced by the novel technology can be used in many applications e.g, fiber spinning, film forming, surface coating and gluing.

Further specific embodiments provide for that
natural polymers, such as cellulose, hemicellulose, lignin, wood and other plant species can be dissolved by using glyoxylic acid;
the hydroxy groups of the material form with the glyoxylic acid a hemiacetal bond and the cellulose derivative is soluble in excess of glyoxylic acid;
glyoxylic acid monohydrate is used and the temperatures are 50 to 120° C.

The following non-limiting examples illustrate the technology:

### EXAMPLE1

Cellulose forms a hemiacetal bond with glyoxylic acid and the cellulose derivative thus formed is soluble in excess of glyoxylic acid. In the samples shown in FIGS. 2 and 3, monohydrate of glyoxylic acid was used at temperature of 50 to 120° C. The hemiacetal bond forming was found to be reversible and the hemiacetal was hydrolyzed in water. At higher temperatures more stable acetal bonds are formed and water is cleaved off. Thus, a water-soluble carboxylated cellulose is obtained which is reminiscent of CMC (FIG. 2).

If both the concentration of the cellulose and the temperature of the process are high (concentration in excess of 10% by weight) and cellulose solubility is limited, there are formed intermolecular crossbonds between the polymers, and a product with limited solubility in water is obtained. Rather, cellulose particles which swell well in water are achieved (FIG. 3).

### EXAMPLE 2

12 g of dried and Wiley milled birch kraft pulp was mixed with 88 g of 75%-w/w glyoxylic acid (glyoxylic acid 75% and water 25% as a free and hydrated form), and the material was placed in the reactor. The reactor was sealed and flowed with the nitrogen gas to remove oxygen and thus to prevent the oxidiation of glyoxylic acid (this is not mandatory). The temperature was slowly raised to 73° C. (during 2.5 hours) under intensive mixing with 300 rpm and the dissolution was maintained at this temperature for 2 hour. This resulted in a very viscous and tenacious dope).

The dope was diluted to a 5% solution and the cellulose was regenerated by boiling. Most of the glyoxylic acid was removed to form cellulose polymers. Alternatively the dope was diluted with technical ethanol to 5% and precipitated slowly by mixing at room temperature. The white precipitated samples were neutralized, washed and dried at room temperature. The CED viscosities of samples were 60 ml/g with ethanol precipitated sample and 40 ml/g with water-boiled sample.

FIG. 4 shows that when cellulose was precipitated by boiling, in the IR spectrum, the carbonyl group almost totally disappeared to yield a product having a spectrum very similar to that of conventional cellulose.

### EXAMPLE 3

12 g of dried and Wiley milled birch kraft pulp was mixed with 88 g of 75%-w/w glyoxylic acid (glyoxylic acid 75% and water 25% as free and hydrated form), and the material was placed in the reactor. The reactor was sealed and flowed with the nitrogen gas to remove oxygen and thus to prevent the oxidiation of glyoxylic acid. Temperature was then raised during 30 minutes to 75° C. under mechanical stirring and the swelling and dissolution of cellulose was maintained for 2 hours. The obtained material was extremely viscous and sticky gum-like material.

The material was then cooled to 45° C. and diluted with water to 10%-w/w solution (12 g cellulose, 66 g glyoxylic acid and 42 g water). This resulted in a homogeneous, tenacious and very viscous dope (FIG. 5). The cellulose was regenerated by diluting the dope with water at 5% consistency and then heating the sample up to 100° C. Alternatively, precipitation with technical ethanol and >5 M sodium hydroxide were also evaluated. Both methods worked in cellulose regeneration producing white precipitates. Water-boiled sample and ethanol precipitated sample were dried at room temperature and the viscosity of the sample (CED method) was measured; it was 170 ml/g for water-boiled sample and 140 mug for ethanol precipitated sample.

It was also found that the clearing and dissolution points can be significantly lowered by water addition e.g. 12% dope to 10% dope

### EXAMPLE 4

1 g of solvent-exchanged high DP dissolving pulp was mixed with 9 g of 75% glyoxylic acid in the test tube. The test tube was then closed and the mixture was heated to 100° C. and kept there for 3 hours. This resulted to yellowish and clear solution. The solution was diluted with 30 g of distilled water and then boiled again for 10 minutes. The solution consisted of glucose (yield 16.33%), cellobiose and other very small oligosaccharides (FIG. 6). The hydrolysis can be controlled by process parameters (time, temperature and water content).

Table 1 shows the hydrolysis results thus obtained

TABLE 1
Hydrolysis experiments at 100° C. with high DP dissolving pulp

| Sample | To sugars (mainly glucose) |
|---|---|
| Acid hydrolysis with sulfuric acid | 83.56% |
| Acid hydrolysis of filtrated sample | 86.23% |
| No acid hydrolysis after glyoxylic acid | 16.33% |

As will appear, plain glyoxylic acid treatment produced approximately 16% sugars. This indicates that the conversion was very high after treatment with dilute sulfuric acid.

Glyoxylic acid treatment may produce mono-, di- and very small oligosaccharides at equal quantities. No large oligosaccharides can be observed (cf. FIG. 6).

### EXAMPLE 5

12 g of abs CTMP fibers was mixed with 88 g of 75%-w/w glyoxylic acid (glyoxylic acid 75% and water 25% as a free and hydrated form) and the material was placed in the reactor. The reactor was sealed and flowed with the nitrogen gas to remove oxygen and thus to prevent the oxidiation of glyoxylic acid (this is not mandatory). The temperature was slowly raised to 73° C. (during 1 hour) under intensive mixing with 300 rpm and the dissolution was maintained at this temperature for 4 hour. This resulted to brow gum-like material. The dope was diluted to 10% solution at 40° C., when paste-like material started to precipitate. Then the material was further diluted to 5% consistency regenerated by boiling. Brown lignocellulosic material was precipitated. Part of this material was further soluble in 1 M NaHCO₃ solution.

### EXAMPLE 6

10 g of Wiley milled kraft pulp was mixed with 20 g melted glyoxylic acid monohydrate and the mixture was slowly heated to 100° C. under intensive mixing (300 rpm). The reaction was maintained during 3 hours. This resulted to fine powder-like material. The amount of fiber material was low. The material was then washed, filtered and neutralized with NaHCO₃. The neutralization resulted in great swelling and partial gelling of particles. The particles structure was degraded either by increasing pH to 12 or by boiling. This again resulted in typical cellulose particles.

### EXAMPLE 7

80 g Wiley milled pulp was mixed with 100 g glyoxylic acid monohydrate and the mixture was intensively mixed during 4 h at 50° C. with high consistency mixer (Hobart dough mixer). The end product was not soluble in neutral or alkaline water. However, a very viscous gel was obtained when 10 g end product was mixed 40 g of technical 50% glyoxylic acid at 50° C. during 1 hour. The precipitation was performed by diluting gel to 5% solution and increasing the temperature to 70° C. The end product contained various sizes of cellulose materials including cellulose fibers, fine fibrils and precipitated cellulose polymers, as indicated in FIGS. 7a and 7b.

### EXAMPLE 8

40 g Wiley milled kraft cellulose and was mixed with 40 g glyoxylic acid monohydrate and the mixture was then put into Brabender twin screw extruder, where the compounds where mixed and reacted at 90° C. for 15 minutes. This resulted to brownish and plasticized material, which was not soluble in alkaline or neutral water. However, a very viscous and transparent gel was obtained, when 10 g of end product was mixed with 40 g of technical 50% glyoxylic acid at 50° C. during 1 hour. The gel was then diluted to 5% with water and the precipitation was carried out by heating the gel to 80° C. The end product contained high amounts of precipitated cellulose polymers and also various sizes of non-dissolved cellulose particles.

### EXAMPLE 9

As Example 8, but the dissolution was made in 50% magnesium glyoxylate solution.

### EXAMPLE 10

10 g of dried dissolving pulp was mixed with 20 g technical 50% glyoxylic acid (50% glyoxylic acid and 50% water; Sigma-Aldrich) and then intensively mixed at 60° C. with laboratory mixer (300 rpm) during 5 hours. Evaporation of water occurred during the reaction and the final weight of the product was 22 g. Very viscous and transparent gel was obtained, when 10 g of end product was mixed with 40 g of technical 50% glyoxylic acid at 50° C. during 1 hour. The gel was then diluted to 5% with water and the precipitation was carried out by heating the gel to 80° C. The end product contained high amounts of precipitated cellulose polymers, fibrillar material and unreacted fibers.

### EXAMPLE 11

10 g of dried dissolving pulp is mixed with 90 g technical 50% glyoxylic acid (50% glyoxylic acid and 50% water; Sigma-Aldrich) and is then left to stand overnight to obtain even glyoxylic acid distribution inside the fiber strucutre. The pulp is filtered and mechanically pressed until the final dry-matter content is near to 30%. (total weight 33 g) After this the pulp is intensively mixed at 60° C. with a laboratory mixer (300 rpm) under simultaneous removal of water (e.g. low pressure or condensation reactor). The final product is recovered. A very viscous and transparent solution is obtained, when 10 g of end product is mixed with 40 g of technical grade, 50% glyoxylic acid during 1 hour.

### EXAMPLE 12

10 g of dried dissolving pulp is mixed with 20 g technical 50% glyoxylic acid (50% glyoxylic acid and 50% water; Sigma-Aldrich) then intensively mixed at a temperature as low as will allow for the reaction to proceed, typically 40 to 50° C., with high-consistency mixer. Simultaneous removal of water, e.g. in a low pressure or condensation reactor, is performed. A very viscous and transparent solution is obtained by dissolving end product dissolved in water, e.g. at temperatures below 5° C., or in a moderately alkaline solution, pH 8, or in technical grade glyoxylic acid where the acid concentration is as low as possible.

### EXAMPLE 13

Board modification with glyoxylic acid was carried out by impregnating glyoxylic acid monohydrate into blotting board by pressing with a hydraulic press, 30 T (28% of total weight). Different pressing temperatures were applied: 40, 70 and 100° C. Reference samples were pressed equally. Air permeability and tensile properties were measured from samples.

1. A solution of a polysaccharide material in a solvent comprising: an efficient amount of an active compound selected from the group of compounds bearing at least two adjacent carbonyl groups and cationic compounds with an aldehyde group and a quaternary nitrogen atom, capable of reacting with the polysaccharide.

2. The solution according to claim 1, wherein the carbonyl compound is selected from oxocarboxylic acids and derivatives and salts and mixtures thereof

3. The solution according to claim 1, wherein the solvent is a polar solvent.

4. The solution according to claim 1, wherein water is bound to the carbonyl compound.

5. The solution according to claim 1, wherein any free solvent is a non-aqueous solvent.

6. The solution according to claim 5, wherein the solvent is non-nucleophilic solvent.

7. The solution according to claim 1, wherein the polysaccharide material comprises an unmodified polysaccharide having free hydroxy groups.

8. The solution according to claim 1, wherein the polysaccharide material is formed by a fibrous matrix comprising an unmodified polysaccharide polymer having free hydroxy groups.

9. The solution according to claim 1,
comprising 1 to 50% by mass of the polysaccharide material and 50 to 99% by mass of said aqueous solvent.

10. The solution according to claim 1, wherein the concentration of glyoxylic acid or salts thereof is 1 to 85% by mass of the solution.

11. The solution according to claim 1, wherein the concentration of water is less than 25% of the total weight of the solution.

12. The solution according to claim 1, comprising the reaction product of the polysaccharide material with the glyoxylic acid or salt thereof.

13. The solution according to claim 1, comprising a non-aqueous solvent.

14. The solution according to claim 13, wherein the volume ratio of water to non-aqueous solvent is 10 to 90.

15. The solution according to claim 1, wherein at least a part of the water is present in the form of hydrated water.

16. The solution according claim 1, comprising a viscous solution having a viscosity of 100 mPas to 100000 mPas.

17. The solution according to claim 1, comprising saccharide oligomers, saccharide dimers, saccharide monomers or mixtures thereof, nanofibrillar or microfibrillar materials, or partly soluble glyoxylated cellulose particles or combinations and mixtures of any of the preceding.

18. The solution according to claim 1, comprising cellulose as the main polysaccharide component.

19. A method of dissolving a polysaccharide material in an aqueous solvent-, comprising reacting the polysaccharide material with a carbonyl compound having at least two adjacent carbonyl groups or with a cationic compounds with an aldehyde group and a quaternary nitrogen atom, to produce a hemiacetal derivative of the polysaccharide material and dissolving the hemiacetal derivative in an aqueous solvent.

20. The method according to claim 19, comprising dissolving 1 to 50 parts by weight of the unmodified polysaccharide material in 99 to 50 parts by weight of an aqueous solvent, which comprises an active compound selected from carbonyl compounds.

21. The method according to claim 19, comprising mixing 1 to 50 parts by weight of the unmodified polysaccharide material with 99 to 40 parts by weight of a salt of the carbonyl compound in melt phase.

22. The method according to claim 19, wherein the polysaccharide material having free hydroxy groups is reacted with the active compound containing carbonyl groups to provide a hemiacetal derivative of the polysaccharide material.

23. The method according to claim 19, wherein the carbonyl compound is selected from oxocarboxylic acids and derivatives and salts and mixtures thereof

24. The method according to claim 19, comprising dissolving 1 to 50 parts by weight of the polysaccharide material in a aqueous solvent comprising 1 to 40 parts, at least a part of the water being chemically bound to the glyoxylic acid or glyoxylate salt.

25. The method according to claim 19, comprising reacting the polysaccharide with the glyoxylic acid or salt thereof.

26. The method according to claim 19, comprising the steps of contacting the polysaccharide material with the aqueous solution at a temperature of about 5 to 25 degrees to form a dispersion, and increasing the temperature of the dispersion to a temperature of at least 40 degrees.

27. The method according to claim 19, comprising the step of contacting the polysaccharide material at a consistency of 0.1 to 10% by weight with a carbonyl compound in order to derivatize the polysaccharide into a soluble form.

28. The method according to claim 19, wherein the mixture is diluted with water.

29. The method according to claim 19, wherein the mixture is diluted to increase solubility, the temperature being 0-60° C.

30. The method according to claim 19, wherein the final water content is 15-98%.

31. The method according to claim 19, wherein the polysaccharide material comprises an unmodified polysaccharide, said polysaccharide comprising hydroxyl groups.

32. The method according to claim 19, wherein the polysaccharide material is formed by a fibrous matrix comprising an unmodified polysaccharide.

33. (canceled)

34. (canceled)
